(19) United States
(12) Patent Application Publication
(10) Pub. No.: US 2011/0048959 A1
(43) Pub. Date: Mar. 3, 2011

(54) Electrochemically-Activated Liquids Containing Fragrant Compounds

(75) Inventor: Bruce F. Field, Golden Valley, MN (US)

(73) Assignee: TENNANT COMPANY, Minnespolis, MN (US)

(21) Appl. No.: 12/872,157

(22) Filed: Aug. 31, 2010

Related U.S. Application Data
(60) Provisional application No. 61/238,479, filed on Aug. 31, 2009.

(51) Int. Cl. B05B 9/03; C25B 9/10; C25B 1/00

(52) U.S. Cl. 205/334; 204/252; 222/333

(57) ABSTRACT

A device for dispensing a fragrant, electrochemically-activated liquid, the device comprising an electrolysis cell configured to electrochemically activate the liquid and to diffuse one or more fragrant compounds into the liquid to provide the fragrant, electrochemically-activated liquid.

### CROSS-REFERENCE TO RELATED APPLICATION(S)

The present application claims priority to U.S. Provisional Application No. 61/238,479, filed on Aug. 31, 2009, and entitled “Electrochemically-Activated Liquids Containing Fragrant Compounds”, the disclosure of which is incorporated by reference in its entirety.

### FIELD OF THE DISCLOSURE

The present disclosure relates to electrochemically-activated liquids. In particular, the present disclosure relates to systems for imparting fragrances to liquids that are electrochemically activated.

### BACKGROUND

Electrolysis cells are used in a variety of different applications for changing one or more characteristics of a fluid. For example, electrolysis cells have been used in cleaning/sanitizing applications, medical industries, and semiconductor manufacturing processes. Electrolysis cells have also been used in a variety of other applications and have had different configurations. For cleaning/sanitizing applications, electrolysis cells are used to create anolyte electrochemically-activated (EA) liquid and catholyte EA liquid. Anolyte EA liquids have known sanitizing properties, and catholyte EA liquids have known cleaning properties.

Current systems for generating EA liquids may produce mild hypochlorite aromas in raw tap water. However, the effect is unpredictable based on the concentration of sodium chloride required to cause the chemical reaction. Furthermore, dispensing particular concentrations of fragrances into the raw tap water can be difficult to maintain. In addition to the emissions of strong odors, high concentrations of fragrances in dispensed liquids may result in residues of the fragrances remaining on the receiving surfaces.

### SUMMARY

A first aspect of the present disclosure is directed to a device for dispensing a fragrant, electrochemically-activated liquid. The device includes an electrolysis cell configured to electrochemically activate the liquid and to diffuse one or more fragrant compounds into the liquid to provide the fragrant, electrochemically-activated liquid. The device also includes a switch configured to be actuated between a first state and a second state, where the switch energizes the electrolysis cell in the first state and de-energizes the electrolysis cell in the second state. The device further includes a dispenser located downstream from the electrolysis cell and configured to dispense the fragrant, electrochemically-activated liquid.

Another aspect of the present disclosure is directed to an electrolysis cell that includes component that at least partially defining a reaction chamber of the electrolysis cell, where the component compositionally comprises a polymeric material and one or more fragrant compounds. The electrolysis cell also includes an ion exchange membrane, and a first electrode and a second electrode disposed on opposing sides of the ion exchange membrane.

Another aspect of the present disclosure is directed to a method for dispensing a fragrant, electrochemically-activated liquid. The method includes providing a liquid to an electrolysis cell, electrochemically activating a liquid in the electrolysis cell, and diffusing one or more fragrant compounds from the electrolysis cell to the liquid.

### BRIEF DESCRIPTION OF THE DRAWINGS

FIG. 1 is a schematic illustration of a spray bottle for electrochemically activating and dispensing a liquid containing one or more fragrant compounds.

FIG. 2 is a schematic illustration of an example of an electrolysis cell of the spray bottle.

FIG. 3 is a schematic illustration of an alternative spray bottle for electrochemically activating and dispensing a liquid containing one or more fragrant compounds, which includes an electrolysis cell located remotely from a liquid reservoir.

### DETAILED DESCRIPTION

The present disclosure is directed to devices and techniques for adding one or more fragrant compounds to an EA liquid in a manner that does not disrupt the properties of the EA liquid (e.g., cleaning properties). As discussed below, one or more components of the device that come into contact with the liquid are desirably fabricated from compositions having polymeric materials doped with one or more fragrant compounds. This allows the fragrant compounds to diffuse into the liquid in a controlled manner prior to dispensing the resulting EA liquid from the device. The resulting dispensed EA liquid may then emit a pleasant odor based on the received fragrant compound(s).

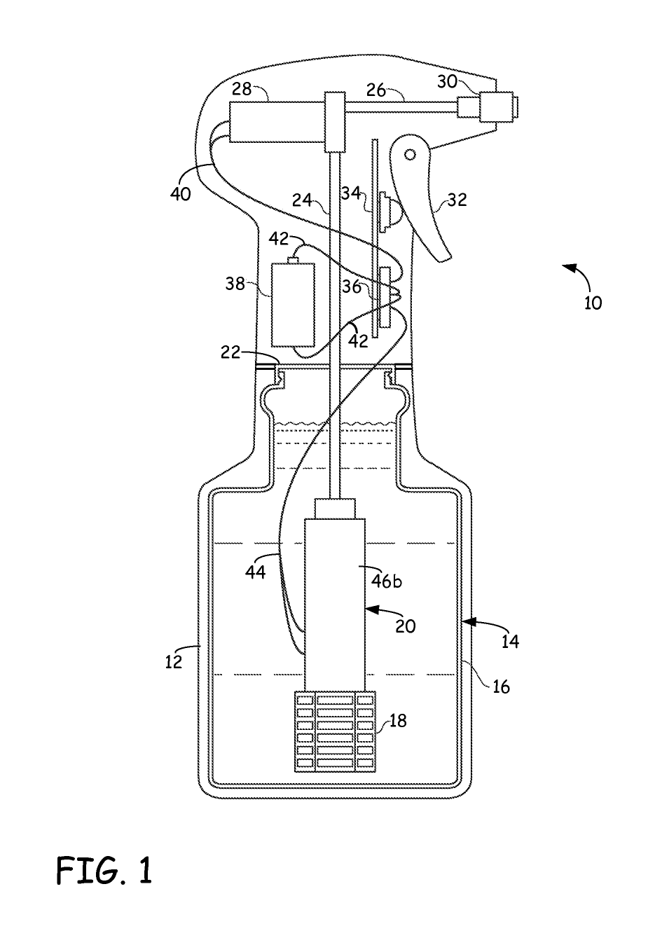

FIG. 1 illustrates spray bottle 10, which is an exemplary hand-held spray bottle configured to dispense a fragranced EA liquid onto one or more surfaces (not shown). Spray bottle 10 includes housing 12, which contains reservoir 14 configured to retain a liquid to be treated and then dispensed. In one embodiment, the liquid to be treated includes an aqueous composition, such as regular tap water. In the shown embodiment, reservoir 14 includes walls 16, which are the perimeter walls of reservoir 16 and are secured at least partially within housing 12 for retaining the liquid. In alternative embodiments, walls 16 may be integrally formed with housing 12 of spray bottle 10.

Spray bottle 10 also includes inlet filter 18, electrolysis cell 20, reservoir cap 22, fluid conduits 24 and 26, pump 28, nozzle 30, actuator 32, switch 34, control electronics 36, and batteries 38. As discussed below, one or more components of walls 16, electrolysis cell 20, and fluid conduits 24 and 26 may compositionally include polymeric materials doped with one or more fragrant compounds. In particularly suitable embodiments, one or more portions of electrolysis cell 20 compositionally include polymeric materials doped with one or more fragrant compounds. This allows the fragrant compound(s) to diffuse into the liquid in a controlled manner. The resulting EA liquid that is dispensed from spray bottle 10 may then emit a pleasant fragrant odor while also reducing residues of the fragrant compounds after the EA liquid is applied to and removed from a surface.

As shown, reservoir cap 22 forms a seal with the neck portion of spray bottle 10, thereby securing the neck portion to housing 12. Examples of suitable designs for spray bottle 10 include those disclosed in Field, U.S. Patent Application Publication No. 2009/0314657; Field, U.S. patent application Ser. No. 12/488,613, entitled “Hand-Held Spray Bottle Electrolysis Cell And DC-DC Converter”; Field, U.S. Patent Application Publication No. 2009/0314654; and Field, U.S. Patent Application Publication No. 2009/0314651.

Pump 28 is desirably an electrically-powered pump that receives electrical power from switch 34 via one or more power lines 40. In alternative embodiments, pump 28 may be located at different locations downstream of electrolysis cell 20 (as shown in FIG. 1), or upstream of electrolysis cell 20 with respect to the direction of liquid flow from reservoir 14 to nozzle 30. Additionally, pump 28 may function as a mechanical pump, such as a hand-triggered positive displacement pump, where actuator 32 may act directly on the pump by mechanical action. In this embodiment, switch 34 may be separately actuated from pump 28, such as a power switch, to energize electrolysis cell 20.

Nozzle 30 is a dispensing nozzle for dispensing streams of the fragrant EA liquid. In various embodiments, nozzle 30 may have different settings (or may be adjustable to multiple settings), thereby allowing the stream to have different dispensing states (e.g., squirting a stream, aerosolizing a mist, and dispensing a spray). Actuator 32 is a trigger-style actuator, which actuates switch 34 between open and closed states. In alternative embodiments, actuator 32 may exhibit other styles and operations, or may be omitted in further embodiments. In embodiments that lack a separate actuator, switch 34 can be actuated directly by a user. Switch 34 may operate with a variety of different actuator designs. Examples of suitable actuator designs include push-button switches (e.g., as shown in FIG. 1), toggles, rockers, mechanical linkages, non-mechanical sensors (e.g., capacitive, resistive plastic, thermal, and inductive sensors), and combinations thereof. Switch 34 can also have a variety of different contact arrangements, such as momentary, single-pole, single throw, and the like.

Batteries 38 include one or more disposable batteries and/or rechargeable batteries, and provide electrical power to electrolysis cell 20 and pump 28 when energized by control electronics 36, as discussed below. In the shown embodiment, batteries 38 supply power to control electronics 36 via one or more power lines 42, and control electronics 36 provide electrical power to pump 28 via power line 40 (as discussed above) and to electrolysis cell 20 via one or more power lines 44. Examples of suitable batteries and control electronics for batteries 38 and control electronics 36 include those disclosed in the above-discussed patent applications for the suitable designs for spray bottle 10. In alternative embodiments, the electrical power provided to electrolysis cell 20 and pump 28 may be provided from an external power source.

When switch 34 is in the open, non-conducting state, control electronics 36 de-energizes electrolysis cell 20 and pump 28. This prevents pump 28 from pumping liquid through spray bottle 10, and prevents electrolysis cell 20 from electrochemically activating the liquid. Alternatively, when a user engages actuator 32, the motion of actuator 32 closes switch 34 to a closed, conducting state, thereby allowing control electronics 36 to energize electrolysis cell 20 and pump 28. Pump 28 then draws liquid from reservoir 14 through filter 18, electrolysis cell 20, and fluid conduit 24, and forces the resulting fragrant EA liquid out of fluid conduit 26 and nozzle 30.

As discussed below, spray bottle 10 may contain a liquid to be dispensed on a surface. In one embodiment, electrolysis cell 20 converts the liquid from reservoir 14 into an anolyte EA liquid and a catholyte EA liquid prior to being dispensed from spray bottle 10. The anolyte and catholyte EA liquids can be dispensed as a combined mixture or as separate spray outputs, such as through separate tubes and/or nozzles (e.g., nozzle 30). In the embodiment shown in FIG. 1, the anolyte and catholyte EA liquids are dispensed as a combined mixture. With a small and intermittent output flow rate provided by spray bottle 10, electrolysis cell 20 can have a small package and be powered by batteries 38.

Electrolysis cell 20 is a fluid treatment cell that is adapted to apply an electric field across the liquid between at least one anode electrode and at least one cathode electrode. In addition, electrolysis cell 20 is configured to diffuse one or more fragrant compounds into the liquid flowing through electrolysis cell 20. In alternative embodiments, spray bottle 10 may include multiple electrolysis cells 20 that operate in series and/or parallel arrangements to electrochemically activate the liquid. In these embodiments, one or more of the multiple electrolysis cells 20 may be configured to diffuse the fragrant compounds into the liquid.

The liquid is supplied to electrolysis cell 20 through filter 18, which correspondingly receives the liquid from reservoir 14. In one embodiment, the liquid may flow through electrolysis cell 20 as separate streams. Alternatively, the liquid may be separated after entering electrolysis cell 20. As the liquid flows through electrolysis cell 20, the electric field applied across the liquid in electrolysis cell 20 electrochemically activates the liquid, which separates the liquid by collecting positive ions (i.e., cations, H⁺) on one side of an electric circuit and collecting negative ions (i.e., anions, OH⁻) on the opposing side. The liquid having the cations is thereby rendered acidic and the liquid having the anions is correspondingly rendered alkaline.

Additionally, one or more fragrant compounds are diffused from electrolysis cell 20 into the liquid flowing through electrolysis cell 20. Thus, the diffusion of the fragrant compound(s) may occur simultaneously with the electrochemical activation of the liquid. Limiting the diffusion of the fragrant compound(s) to a residence time of the liquid within electrolysis cell 20 provides a high level of control over the concentration of the fragrant compound(s) that diffuse into the liquid, particularly during regular use of spray bottle 10. This reduces the risk of diffusing high concentrations of the fragrant compound(s) into the liquid, which can result in undesirably strong odors and residues of the fragrant compound(s). Moreover, high concentrations of the fragrant compound(s) in the liquid may potentially reduce the electrochemical activation of the liquid within electrolysis cell 20.

The concentration of the fragrant compound(s) that diffuse into the liquid within electrolysis cell 20 may vary depending on factors such as the concentration of the fragrant compound(s) in electrolysis cell 20, the diffusion rate of the fragrant compound(s) from electrolysis cell 20, and the residence time of the liquid in electrolysis cell 20. As discussed below, the concentration of the fragrant compound(s) in electrolysis cell 20 may be set to accommodate a particular residence time of the liquid in electrolysis cell 20, which is correspondingly based on the flow rate of the liquid through electrolysis cell 20.

Examples of suitable concentrations of the fragrant compound(s) in the EA liquid dispensed from spray bottle 10 range from about 1 part-per-million (ppm) by volume to about 1% by volume (i.e., about 10,000 ppm by volume), with particularly suitable concentrations ranging from about 10 ppm by volume to about 1,000 ppm by volume, and with even more particularly suitable concentrations ranging from about 100 ppm to about 500 ppm by volume, based on an entire volume of the EA liquid dispensed from nozzle 30. The resulting EA liquid that is dispensed from nozzle 30 may then emit a pleasant fragrant odor while also reducing residues of the fragrant compounds after the EA liquid is applied to and removed from a surface.

The electrolysis process may also restructure the liquid by breaking the liquid into smaller units that can penetrate cells much more efficiently than a normal liquid. For example, most tap water and bottled water are made of large conglomerates of unstructured water molecules that are too large to move efficiently into cells. The EA liquid, however, is a structured liquid that penetrates the cells at a much faster rate for better nutrient absorption and more efficient waste removal. Smaller liquid units also have a positive effect on the efficiency of metabolic processes.

The resulting streams of the fragrant EA liquid may exit electrolysis cell 20 and recombined in fluid conduit 24. Alternatively, the liquid stream rendered acidic and the liquid stream rendered alkaline may be recombined prior to exiting electrolysis cell 20, and the combined stream may through fluid conduit 24 as the desired liquid product stream. As discussed below, despite being recombined, the acidic water and the alkaline water retain their ionic properties and gas-phase bubbles for a sufficient duration to allow the liquid to be dispensed onto a surface.

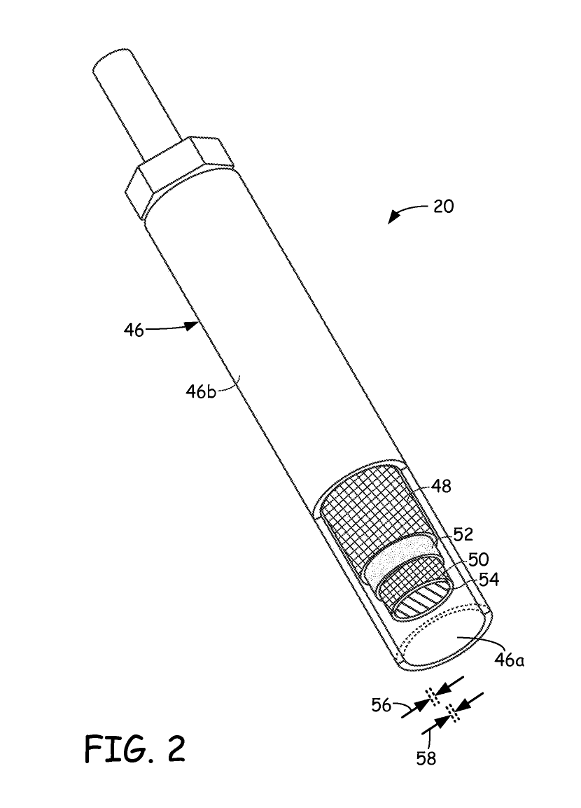

FIG. 2 is a perspective view of electrolysis cell 20 having a tubular shape, where portions of electrolysis cell 20 are cut away for ease of discussion. In alternative embodiments, electrolysis cell 20 may exhibit a variety of different shapes, such as planar, coaxial plates, cylindrical rods, and combinations thereof. In the embodiment shown in FIG. 2, electrolysis cell 20 includes cell housing 46, which is a first housing component of electrolysis cell 20. Electrolysis cell 20 also includes tubular outer electrode 48 and tubular inner electrode 50, where inner electrode 50 is separated from outer electrode 48 by a suitable gap (e.g., about 0.040 inches). Other gap sizes can also be used, such as but not limited to gaps in the range of 0.020 inches to 0.080 inches. Electrolysis cell 20 also includes membrane 52 and core cylinder 54, where membrane 52 is positioned between outer electrode 48 and inner electrode 50. Core cylinder 54 is a second housing component of electrolysis cell 20, which promotes liquid flow along and between electrodes 48 and 50 and membrane 52.

This arrangement divides electrolysis cell 20 into anode chamber 56 and cathode chamber 58, where the liquid flow is conductive and completes an electrical circuit between outer electrode 48 and inner electrode 50. Anode chamber 56 is an annular chamber (for example) located between cell housing 46 and membrane 52, and includes outer electrode 48. Correspondingly, cathode chamber 58 is an annular chamber (for example) located between membrane 52 and core cylinder 54, and includes inner electrode 50. As such, outer electrode 48 may be referred to as anode electrode 48 and inner electrode 50 may be referred to as cathode electrode 50. In an alternative embodiment, the polarities of outer electrode 48 and inner electrode 50 may be reversed such that outer electrode 48 would be a cathode electrode and inner electrode 50 would be an anode electrode. Additionally, while electrolysis cell 20 is illustrated in FIG. 2 as having a single anode chamber and a single cathode chamber, electrolysis cell 20 may alternatively include a plurality of anode and cathode chambers separated by one or more membranes 52.

Electrolysis cell 20 can have any suitable dimensions. In one example, electrolysis cell 20 can have a length of about 4 inches long and an outer diameter of about ¾ inch. The length and diameter can be selected to control the treatment time and the quantity of bubbles (e.g., nanobubbles and/or microbubbles) generated per unit volume of the liquid. Electrolysis cell 20 may also include a suitable fitting at one or both ends of the cell. Any method of attachment can be used, such as through plastic quick-connect fittings. For example, one fitting can be configured to connect to fluid conduit 24 (shown in FIG. 1). Another fitting can be configured to connect to the inlet filter 18 or an inlet tube. In another example, one end of cell 20 is left open to draw liquid directly from reservoir 14 (shown in FIG. 1). Examples of suitable designs for electrolysis cell 20 include those disclosed in Field, U.S. Patent Application Publication No. 2009/0314659.

Cell housing 46 is an outer tubular housing for electrolysis cell 20, and, as discussed above, partially forms anode chamber 56. In addition, cell housing 46 is desirably fabricated (e.g., injection molded) from a composition that contains a polymeric material doped with one or more fragrant compounds. This allows the fragrant compounds to diffuse from the inner surface of cell housing 46 (referred to as inner surface 46a) into the liquid stream flowing through anode chamber 56 during electrolysis.

The polymeric material for the composition of cell housing 46 may include one or more thermoplastic materials. Examples of suitable thermoplastic materials include polyolefin polymers, polyolefin elastomers, polyamide-based polymers (e.g., nylons), and combinations thereof. Examples of suitable polyolefin polymers and elastomers include polyethylenes, polypropylenes, ethylene propylene rubbers (e,g., ethylene propylene diene monomer EPDM rubbers), ethylene vinyl acetates (EVA), styrene-block copolymers (e.g., acrylonitrile-butadiene-styrene (ABS) copolymers), poly vinyl chlorides (PVC), and combinations thereof.

Examples of suitable fragrant compounds may vary depending on the desired odors to produce. The fragrant compound(s) may also be compounded with the polymeric material from a variety of media (e.g., fragrance oils, powders, salts, peroxides, and/or solvents). Examples of suitable fragrance odors include those under one or more of the floral families, the oriental families, the woody families, the aromatic fougere families, and the fresh families. Examples of suitable commercially available compositions for fabricating cell housing 46 include resins available under the trade designation “POLYSCENT” from Polyvel Inc., Hammonton, N.J.

Suitable concentrations of the fragrant compound(s) in the composition may vary depending on the desired odor intensity to be emitted from the EA liquid that is sprayed from spray bottle 10. Examples of suitable concentrations of the fragrant compound(s) in the polymeric material of cell housing 46 range from about 1% by weight to about 40% by weight, with particularly suitable concentrations ranging from about 3% by weight to about 30% by weight, and with even more particularly suitable concentrations ranging from about 5% by weight to about 20% by weight, based on an entire weight of the composition of cell housing 46. These concentrations are suitable for providing the above-discussed suitable concentrations of the fragrant compound(s) in the EA liquids sprayed from nozzle 30.

In the shown embodiment, the entirety of cell housing 46 may be fabricated from the composition containing the polymeric material doped with the fragrant compound(s). In this embodiment, because the outer surface of cell housing 46 (referred to as outer surface 46b) is exposed to reservoir 14 (as shown in FIG. 1), the fragrant compound(s) may also diffuse into the liquid retained in reservoir 14. This allows at least a portion of the diffusion process to occur during storage and prior to use.

As discussed below, in alternative embodiments, the electrolysis cell (e.g., electrolysis cell 20) may be located in other portions of housing 12 (e.g., adjacent to pump 28 and nozzle 30). In these embodiments, the electrolysis cell may be located remotely from the reservoir (e.g., reservoir 14) such that the cell housing (e.g., cell housing 46) is not in contact with the liquid retained in the reservoir. This effectively restricts the diffusion of the fragrant compound(s) to the liquid flowing through the electrolysis cell, the fluid conduits, and/or the pump, thereby providing a high level of control over the diffusion rates.

In a first alternative embodiment, cell housing 46 may be a multi-layer housing that includes an outer layer exposed to reservoir 14 at outer surface 46b and an inner layer forming a portion of anode chamber 56 at inner surface 46a. In this embodiment, the outer layer is desirably fabricated from a polymeric material without any fragrant compounds, and the inner layer is desirably fabricated from the composition discussed above containing a polymeric material doped with fragrant compound(s). As such, the diffusion of the fragrant compound(s) into the liquid may be restricted to the liquid flowing through electrolysis cell 20 (e.g., through anode chamber 56).

In a second alternative embodiment, cell housing 46 may be fabricated from a composition having concentration gradient of the fragrant compound that is substantially zero at outer surface 46b and increases axially inward toward inner surface 46a. This embodiment provides the same benefits of restricting the diffusion of the fragrant compound(s) to the liquid flowing through electrolysis cell 20 (e.g., through anode chamber 56), as discussed above for the two-layer cell housing 46.

Furthermore, in an additional embodiment, which may be used in combination with the above-discussed embodiments for cell housing 46, or as an alternative to a fragrant compound-diffusing cell housing 46, core cylinder 54 may be fabricated from a composition containing a polymeric material doped with one or more fragrant compounds. Alternatively, core cylinder 54 may include an outer layer that compositionally contains the polymeric material doped with one or more fragrant compounds. Examples of suitable compositions for fabricating core cylinder 54 include those discussed above for cell housing 46. This embodiment is beneficial for diffusing the fragrant compound(s) into the stream of liquid flowing through cathode chamber 58.

In additional embodiments, one or more of walls 16 of reservoir 14 and fluid conduits 24 and 26 may also be fabricated from compositions containing polymeric materials doped with one or more fragrant compounds. Examples of suitable compositions for fabricating wall 16, and fluid conduits 24 and 26 also include those discussed above for cell housing 46. These embodiments are beneficial for use with compositions having low concentrations of the fragrant compound(s), thereby increasing the surface area and residence times that the liquid is in contact with the fragrant-compound-diffusing surfaces.

Membrane 52 is an ion exchange membrane, such as a cation exchange membrane (i.e., a proton exchange membrane) or an anion exchange membrane. Suitable cation exchange membranes for membrane 52 include partially and fully fluorinated ionomers, polyaromatic ionomers, and combinations thereof. Examples of suitable commercially available ionomers for membrane 52 include sulfonated tetrafluorethylene copolymers available under the trademark “NAFION” from E.I. du Pont de Nemours and Company, Wilmington, Del.; perfluorinated carboxylic acid ionomers available under the trademark “FLEMION” from Asahi Glass Co., Ltd., Japan; perfluorinated sulfonic acid ionomers available under the trademark “ACIPLEX” Aciplex from Asahi Chemical Industries Co. Ltd., Japan; and combinations thereof.

Anode electrode 48 and cathode electrode 50 can be made from any suitable electrically-conductive material, such as titanium, and may be coated with one or more precious metals (e.g., platinum). Anode electrode 48 and cathode electrode 50 may each also exhibit a variety of different geometric designs and constructions, such as flat plates, coaxial plates (e.g., for tubular electrolytic cells), rods, and combinations thereof; and may have solid constructions or can have one or more apertures (e.g., metallic meshes). While anode chamber 56 and cathode chamber 58 are each illustrated with a single anode electrode 48 and cathode electrode 50, anode chamber 56 may include a plurality of anode electrodes 48, and cathode chamber 58 may include a plurality of cathode electrodes 50.

In one embodiment, one or both of anode electrode 48 and cathode electrode 50 may include one or more conductive polymers as disclosed in Field, U.S. Patent Application Publication No. 2009/0314657. In this embodiment, the conductive polymers may also be doped with one or more fragrant compounds, as discussed above. Examples of suitable concentrations of the fragrant compound(s) in the conductive polymer(s) include those discussed above for the composition of cell housing 46. Accordingly, this conductive polymer embodiment may be incorporated into spray bottle 10 be an additional source of diffusible fragrant compound(s), or an alternative source of diffusible fragrant compound(s), to the above-discussed embodiments.

Anode electrode 48 and cathode electrode 80 may be electrically connected to opposing terminals of a conventional power supply (e.g., batteries 38). The power supply can provide electrolysis cell 20 with a constant direct-current (DC) output voltage, a pulsed or otherwise modulated DC output voltage, or a pulsed or otherwise modulated AC output voltage, to anode electrode 48 and cathode electrode 50. The power supply can have any suitable output voltage level, current level, duty cycle, or waveform. In one embodiment, the power supply applies the voltage supplied to anode electrode 48 and cathode electrode 50 at a relative steady state. The power supply includes a DC/DC converter that uses a pulse-width modulation (PWM) control scheme to control voltage and current output. Other types of power supplies can also be used, which can be pulsed or not pulsed, and at other voltage and power ranges. The parameters are application-specific. The polarities of anode electrode 48 and cathode electrode 50 may also be flipped during operation to remove any scales that potentially form on anode electrode 48 and cathode electrode 50.

During operation, the liquid is supplied to electrolysis cell 20 from reservoir 14, and is desirably separated into separate streams after passing through filter 18. A first stream of the liquid flows into anode chamber 56, and a second stream of the liquid flows into cathode chamber 58. A voltage potential is applied to electrochemically activate the liquid flowing through anode chamber 56 and cathode chamber 58. For example, in an embodiment in which membrane 52 is a cation exchange membrane, a suitable voltage (e.g., a DC voltage) potential is applied across anode electrode 48 and cathode electrode 50. The actual potential required at any position within electrolysis cell 20 may be determined by the local composition of the liquid. In addition, a greater potential difference (i.e., over potential) is desirably applied across anode electrode 48 and cathode electrode 50 to deliver a significant reaction rate. Platinum-based electrodes typically require an addition of about one-half of a volt to the potential difference between the electrodes. In addition, a further potential is desirable to drive the current through electrolysis cell 20.

Upon application of the voltage potential across anode electrode 48 and cathode electrode 50, cations (e.g., H⁺) generated in the liquid of anode chamber 56 transfer across membrane 52 towards cathode electrode 50, while anions (e.g., OH⁻) generated in the liquid of anode chamber 56 move towards anode electrode 48. Similarly, cations (e.g., H⁺) generated in the liquid of cathode chamber 58 also move towards cathode electrode 50, and anions (e.g., OH⁻) generated in the liquid of cathode chamber 58 attempt to move towards anode electrode 48. However, membrane 52 prevents the transfer of the anions present in cathode chamber 58. Therefore, the anions remain confined within cathode chamber 58.

In addition to the electrochemical activation, the fragrant compound(s) also desirably diffuse from cell housing 46 and/or core cylinder 54 into one or more both of the liquid streams flowing through anode chamber 56 and cathode chamber 58. While the electrolysis continues, the anions in the liquid bind to the metal atoms (e.g., platinum atoms) at anode electrode 48, and the cations in the liquid (e.g., hydrogen) bind to the metal atoms (e.g., platinum atoms) at cathode electrode 50. These bound atoms diffuse around in two dimensions on the surfaces of the respective electrodes until they take part in further reactions. Other atoms and polyatomic groups may also bind similarly to the surfaces of anode electrode 48 and cathode electrode 50, and may also subsequently undergo reactions. Molecules such as oxygen (O₂) and hydrogen (H₂) produced at the surfaces may enter small cavities in the liquid phase of the liquid (i.e., bubbles) as gases and/or may become solvated by the liquid phase.

Surface tension at a gas-liquid interface is produced by the attraction between the molecules being directed away from the surfaces of anode electrode 48 and cathode electrode 50 as the surface molecules are more attracted to the molecules within the liquid than they are to molecules of the gas at the electrode surfaces. In contrast, molecules of the bulk of the liquid are equally attracted in all directions. Thus, in order to increase the possible interaction energy, surface tension causes the molecules at the electrode surfaces to enter the bulk of the liquid.

The electrolysis process may also generate gas-phase bubbles, where the sizes of the gas-phase bubbles may vary depending on a variety of factors, such as the pressure through electrolysis cell 20 and the extent of the electrochemical activation. Accordingly, the gas-phase bubbles may have a variety of different sizes, including, but not limited to macrobubbles, microbubbles, nanobubbles, and mixtures thereof. In embodiments including macrobubbles, examples of suitable average bubble diameters for the generated bubbles include diameters ranging from about 500 micrometers to about one millimeter.

In embodiments including microbubbles, examples of suitable average bubble diameters for the generated bubbles include diameters ranging from about one micrometer to less than about 500 micrometers. In embodiments including nanobubbles, examples of suitable average bubble diameters for the generated bubbles include diameters less than about one micrometer, with particularly suitable average bubble diameters including diameters less than about 500 nanometers, and with even more particularly suitable average bubble diameters including diameters less than about 100 nanometers.

In the embodiments in which gas-phase nanobubbles are generated, the gas contained in the nanobubbles (i.e., bubbles having diameters of less than about one micrometer) are also believed to be stable for substantial durations in the liquid phase, despite their small diameters. While not wishing to be bound by theory, it is believed that the surface tension of the liquid, at the gas/liquid interface, drops when curved surfaces of the gas bubbles approach molecular dimensions. This reduces the natural tendency of the nanobubbles to dissipate.

Furthermore, nanobubble gas/liquid interface is charged due to the voltage potential applied across membrane 52. The charge introduces an opposing force to the surface tension, which also slows or prevents the dissipation of the nanobubbles. The presence of like charges at the interface reduces the apparent surface tension, with charge repulsion acting in the opposite direction to surface minimization due to surface tension. Any effect may be increased by the presence of additional charged materials that favor the gas/liquid interface.

The natural state of the gas/liquid interfaces appears to be negative. Other ions with low surface charge density and/or high polarizability (such as Cl⁻, ClO⁻, HO₂⁻, and O₂⁻) also favor the gas/liquid interfaces, as do hydrated electrons. Aqueous radicals also prefer to reside at such interfaces. Thus, it is believed that the nanobubbles present in the catholyte (i.e., the sub-stream flowing through cathode chamber 58) are negatively charged, but those in the anolyte (i.e., the sub-stream flowing through anode chamber 56) will possess little charge (the excess cations cancelling out the natural negative charge). Accordingly, catholyte nanobubbles are not likely to lose their charge on mixing with the anolyte sub-stream at the subsequent convergence point, and are otherwise stable for a duration that is greater than the residence time of the resulting EA liquid within spray bottle 10.

Additionally, gas molecules may become charged within the nanobubbles (such as O₂⁻), due to the excess potential on the cathode, thereby increasing the overall charge of the nanobubbles. The surface tension at the gas/liquid interface of charged nanobubbles can be reduced relative to uncharged nanobubbles, and their sizes stabilized. This can be qualitatively appreciated as surface tension causes surfaces to be minimized, whereas charged surfaces tend to expand to minimize repulsions between similar charges. Raised temperature at the electrode surface, due to the excess power loss over that required for the electrolysis, may also increase nanobubble formation by reducing local gas solubility.

As the repulsion force between like charges increases inversely as the square of their distances apart, there is an increasing outwards pressure as a bubble diameter decreases. The effect of the charges is to reduce the effect of the surface tension, and the surface tension tends to reduce the surface whereas the surface charge tends to expand it. Thus, equilibrium is reached when these opposing forces are equal. For example, assuming the surface charge density on the inner surface of a gas bubble (radius r) is Φ(e⁻/meter²), the outwards pressure (“Pₒᵤₜ”), can be found by solving the NavierStokes equations to give:

Pₒᵤₜ=Φ²/2Dε₀ (Equation 1)

where D is the relative dielectric constant of the gas bubble (assumed unity), “ε₀” is the permittivity of a vacuum (i.e., 8.854 pF/meter). The inwards pressure (“Pᵢₙ”) due to the surface tension on the gas is:

Pᵢₙ=2 g/r Pₒᵤₜ (Equation 2)

where “g” is the surface tension (0.07198 Joules/meter² at 25° C.). Therefore if these pressures are equal, the radius of the gas bubble is:

r=0.28792 ε₀/Φ². (Equation 3)

Accordingly, for nanobubble diameters of 5 nanometers, 10 nanometers, 20 nanometers, 50 nanometers, and 100 nanometers the calculated charge density for zero excess internal pressure is 0.20, 0.14, 0.10, 0.06 and 0.04 e⁻/nanometer² bubble surface area, respectively. Such charge densities are readily achievable with the use of electrolysis cell 20. The nanobubble radius increases as the total charge on the bubble increases to the power ⅔. Under these circumstances at equilibrium, the effective surface tension of the liquid at the nanobubble surface is zero, and the presence of charged gas in the bubble increases the size of the stable nanobubble. Further reduction in the bubble size would not be indicated as it would cause the reduction of the internal pressure to fall below atmospheric pressure.

In various situations within electrolysis cell 46, the nanobubbles may divide into even smaller bubbles due to the surface charges. For example, assuming that a bubble of radius “r” and total charge “q” divides into two bubbles of shared volume and charge (radius r½=r2^{1/3}, and charge q_{1/2}q/2), and ignoring the Coulomb interaction between the bubbles, calculation of the change in energy due to surface tension (ΔE_{ST}) and surface charge (ΔE_{q}) gives:

$$\begin{matrix}Δ {E}_{ST} = + 2 ( 4 πγ {{r}_{1 / 2}}^{2} ) - 4 π γ {r}^{2} = 4 π γ {r}^{2} ( {2}^{1 / 3} - 1 ) \\ and & ( Equation 3 ) \\ Δ {E}_{q} = - 2 [ \frac{1}{2} \times \frac{{[ q / 2 ]}^{2}}{4 {πɛ}_{0} {r}_{1 / 2}} ] - \frac{1}{2} \times \frac{{q}^{2}}{4 {πɛ}_{0} r} = \frac{{q}^{2}}{8 {πɛ}_{0} r} [ 1 - {2}^{- 2 / 3} ] & ( Equation 4 )\end{matrix}$$

The bubble is metastable if the overall energy change is negative which occurs when ΔE_{ST}+ΔE_{q} is negative, thereby providing:

$$\frac{{q}^{2}}{8 {πɛ}_{0} r} [ 1 - {2}^{- 2 / 3} ] + 4 πγ {r}^{2} [ {2}^{1 / 3} - 1 ] \leq 0 \qquad ( Equation 5 )$$

which provides the relationship between the radius and the charge density (Φ):

$$Φ = \frac{q}{4 π {r}^{2}} \geq \sqrt{\frac{2 {γɛ}_{0}}{r} \frac{[ {2}^{1 / 3} - 1 ]}{[ 1 - {2}^{- 2 / 3} ]}} \qquad ( Equation 6 )$$

Accordingly, for nanobubble diameters of 5 nanometers, 10 nanometers, 20 nanometers, 50 nanometers, and 100 nanometers the calculated charge density for bubble splitting 0.12, 0.08, 0.06, 0.04 and 0.03 e⁻/nanometer² bubble surface area, respectively. For the same surface charge density, the bubble diameter is typically about three times larger for reducing the apparent surface tension to zero than for splitting the bubble in two. Thus, the nanobubbles will generally not divide unless there is a further energy input.

The fragrant EA liquid, containing the gas-phase bubbles (e.g., macrobubbles, microbubbles, and nanobubbles), exits electrolysis cell 20 and the sub-streams may re-converge at fluid conduit 24. Although the anolyte and catholyte fuels are blended prior to being dispensed from spray bottle 10, they are initially not in equilibrium and temporarily retain their electrochemically-activated states. Accordingly, the fragrant EA liquid contains gas-phase bubbles dispersed/suspended in the liquid-phase.

In one example, the diameters of fluid conduits 24 and 26 have small inner diameters such that, once electrolysis cell 20 and pump 28 are energized, fluid conduits 24 and 26 are quickly primed with the fragrant EA liquid. Any non-activated liquid contained in the tubes and pump are kept to a small volume. Thus, in the embodiment in which the control electronics 36 activate electrolysis cell 20 and pump 28 in response to actuation of switch 34, spray bottle 10 produces the blended, fragrant EA liquid at nozzle 30 in an “on demand” fashion and dispenses substantially all of the combined anolyte and catholyte EA liquid (except that retained in fluid conduits 24 and 26, and pump 28) without an intermediate step of storing the anolyte and catholyte EA liquids. When switch 34 is not actuated, pump 28 is in an “off” state and electrolysis cell 20 is de-energized. When switch 34 is actuated to a closed state, control electronics 36 switches pump 28 to an “on” state and energizes electrolysis cell 20. In the “on” state, pump 28 pumps water from reservoir 14 through electrolysis cell 20, and out nozzle 30 as a stream. Other activation sequences can also be used. For example, control circuit 36 can be configured to energize electrolysis cell 20 for a period of time before energizing pump 28 in order to allow the liquid to become more electrochemically activated before dispensing.

The travel time from electrolysis cell 20 to nozzle 30 can be made very short. In one example, spray bottle 10 dispenses the blended anolyte and catholyte liquid within a very small period of time from which the anolyte and catholyte liquids are produced by electrolysis cell 20. For example, the blended EA liquid can be dispensed within time periods such as within 5 seconds, within 3 seconds, and within 1 second of the time at which the anolyte and catholyte liquids are produced.

The above-discussed gas-phase nanobubbles are adapted to attach to particles of dirt and grease, thereby transferring their ionic charges. The nanobubbles stick to hydrophobic surfaces, which releases water molecules from the high energy water/hydrophobic surface interface with a favorable negative free energy change. Additionally, the nanobubbles spread out and flatten on contact with the hydrophobic surface, thereby reducing the curvatures of the nanobubbles with consequential lowering of the internal pressure caused by the surface tension. This provides additional favorable free energy release. The charged and coated particles are then more easily separated one from another due to repulsion between similar charges, and dirt particles may enter the solution as colloidal particles.

Furthermore, the presence of nanobubbles on the surface of particles increases the pickup of the particle by micron-sized gas-phase bubbles, which may also be generated during the electrochemical activation process. The presence of surface nanobubbles also reduces the size of the particle that can be picked up by this action. Moreover, due to the large gas/liquid surface area-to-volume ratios that are attained with gas-phase nanobubbles, water molecules located at this interface are held by fewer hydrogen bonds, as recognized by water's high surface tension. Due to this reduction in hydrogen bonding to other water molecules, this interface water is more reactive than normal water and will hydrogen bond to other molecules more rapidly, thereby showing faster hydration.

For example, at 100% efficiency a current of one ampere is sufficient to produce 0.5/96,485.3 moles of hydrogen (H2) per second, which equates to 5.18 micromoles of hydrogen per second, which correspondingly equates to 5.18×22.429 microliters of gas-phase hydrogen per second at a temperature of 0° C. and a pressure of one atmosphere. This also equates to 125 microliters of gas-phase hydrogen per second at a temperature of 20° C. and a pressure of one atmosphere. As the partial pressure of hydrogen in the atmosphere is effectively zero, the equilibrium solubility of hydrogen in the electrolyzed solution is also effectively zero and the hydrogen is held in gas cavities (e.g., macrobubbles, microbubbles, and/or nanobubbles).

Assuming the flow rate of the electrolyzed solution is 0.12 U.S. gallons per minute, there is 7.571 milliliters of water flowing through the electrolysis cell each second. Therefore, there are 0.125/7.571 liters of gas-phase hydrogen within the bubbles contained in each liter of electrolyzed solution at a temperature of 20° C. and a pressure of one atmosphere. This equates to 0.0165 liters of gas-phase hydrogen per liter of solution less any of gas-phase hydrogen that escapes from the liquid surface and any that dissolves to supersaturate the solution.

The volume of a 10 nanometer-diameter nanobubble is 5.24×10-22 liters, which, on binding to a hydrophobic surface covers about 1.25×10-16 square meters. Thus, in each liter of solution there would be a maximum of about 3×10-19 bubbles (at 20° C. and one atmosphere) with combined surface covering potential of about 4000 square meters. Assuming a surface layer just one molecule thick, this provides a concentration of active surface water molecules of over 50 millimoles. While this concentration represents a maximum amount, even if the nanobubbles have greater volume and greater internal pressure, the potential for surface covering remains large. Furthermore, only a small percentage of the particles surfaces need to be covered by the nanobubbles for the nanobubbles to have a removal effect.

Accordingly, the gas-phase nanobubbles, generated during the electrochemical activation process, are beneficial for attaching to cosmetic substance particles so transferring their charge. The resulting charged and coated particles are more readily separated one from another due to the repulsion between their similar charges. They will enter the solution to form a colloidal suspension. Furthermore, the charges at the gas/water interfaces oppose the surface tension, thereby reducing its effect and the consequent contact angles. Also, the nanobubbles coating of the particles promotes the pickup of larger buoyant gas-phase macrobubbles and microbubbles that are introduced. In addition, the large surface area of the nanobubbles provides significant amounts of higher reactive water, which is capable of the more rapid hydration of suitable molecules.

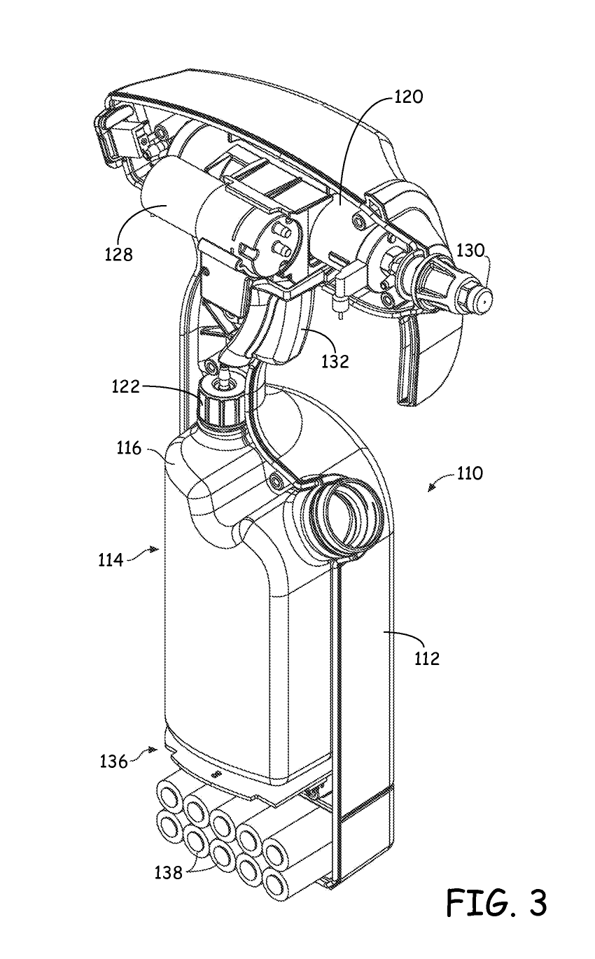

FIG. 3 is a cut-away view of spray bottle 110, which is an alternative to spray bottle 10 (shown in FIG. 1). Examples of suitable designs and methods of use for spray bottle 110 include the embodiments disclosed in U.S. Patent Application Publication No. 2009/0314657, the disclosure of which is incorporated by reference in its entirety. In the embodiment shown in FIG. 3, electrolysis cell 120 is located adjacent to pump 128 and nozzle 130. As discussed above, this places electrolysis cell 120 at a location that is remote from reservoir 114 such that the cell housing that defines a portion of one or both of the anode chamber and the cathode chamber of electrolysis cell 120 is not in contact with the liquid retained the reservoir 114. This effectively restricts the diffusion of the fragrant compound(s) to the liquid flowing through electrolysis cell 120, the fluid conduits, and/or pump 128, thereby providing a high level of control over the diffusion rates.

Spray bottles 10 and 110 are suitable devices for spraying fragrant EA liquids to a variety of surfaces. As discussed above, the fragrant compound(s) are capable of being diffused into the liquid in a controlled manner, and the diffusion process may occur simultaneously with the electrochemical activation of the liquid. The resulting EA liquids that are dispensed from spray bottles 10 and 110 may then emit pleasant fragrant odors while also reducing residues of the fragrant compounds after the EA liquids are applied to and removed from surfaces.

### Examples

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

Spray bottles of Examples 1-8 were prepared and tested to measure their capabilities to emit pleasant fragrant odors. For each example, the spray bottle corresponded to spray bottle 110 (shown in FIG. 3) and included an electrolysis cell having a core cylinder molded with a fragrant compound. In particular, each electrolysis cell corresponded to tubular electrolysis cell 20 (shown in FIG. 2) having core cylinder 54 molded from glass-filled polypropylene and a fragrant compound concentrate. The inclusion of the glass-filled polypropylene stabilized the resulting composition, thereby allowing the core cylinder to be molded more efficiently.

### Example 1

A spray bottle of Example 1 included an electrolysis cell core cylinder molded from 25% by weight glass-filled polypropylene and 75% by weight of a citrus concentrate. The citrus concentrate was commercially available from Polyvel Inc., Hammonton, N.J., and included 25% by weight of a citrus oil. As such, the resulting molded electrolysis cell core cylinder contained 18.8% by weight of the citrus oil.

### Example 2

A spray bottle of Example 2 included an electrolysis cell core cylinder molded from 25% by weight of the glass-filled polypropylene and 75% by weight of a citrus mixture. The citrus mixture included 95% of a citrus concentrate from Polyvel Inc., Hammonton, N.J., and 5% of a foaming additive. The citrus concentrate included 25% by weight of a citrus oil, and was the same citrus concentrate used for the electrolysis cell core cylinder in Example 1. As such, the resulting molded electrolysis cell core cylinder for Example 2 contained 17.8% by weight of the citrus oil.

### Examples 3-8

Spray bottles of Example 3-8 were prepared in the same manner as discussed above for the spray bottle of Example 2, where the electrolysis cell core cylinders included different fragrant compounds. Table 1 lists the fragrances used to mold each electrolysis cell core cylinder for Examples 3-8, where each fragrance was provided as a concentrate from Polyvel Inc., Hammonton, N.J.

TABLE 1

| Example | Fragrance |
|---|---|
| Example 3 | Lemon |
| Example 4 | Citrus/Lemon Blend |
| Example 5 | grape |
| Example 6 | Raspberry |
| Example 7 | Fresh Rain |
| Example 8 | Rain Flower |

### Test Results for Examples 1-8

The spray bottles of Examples 1-8 were then operated to measure their capabilities to emit pleasant fragrant odors. For each spray bottle, water was filled in the reservoir and allowed to sit for a few minutes at room temperature. The spray bottle was then operated and the resulting fragrance of the output EA spray was then qualitatively measured. For each spray bottle, the intensity of the fragrance in the output EA spray was initially at a higher level that was pleasant (i.e., not too concentrated). As the spray bottle continued to operate, the intensity of the fragrance steadily dropped until a lower intensity was reached and maintained.

The initially higher fragrance intensity is believed to be due to the electrolysis cell core cylinder being exposed to the water for a few minutes prior to operation. This exposure allowed a portion of the fragrant compound in the electrolysis cell core cylinder to diffuse into the water. As the spray operation continued the transient time of the water in contact with the electrolysis cell core cylinder decreased until a steady state diffusion rate was attained based on the flow rate of the water through the electrolysis cell. This combination of a higher initial fragrance intensity, followed by a lower fragrance intensity provided a combination of fragrant odors that was pleasing to the senses.

The spray bottles of Examples 1-8 were also used over multiple spray operations to identify the shelf lives of the diffused fragrant compounds. For each spray bottle, the output EA spray continued to emit pleasant fragrant odors for extended periods of use. As such, the spray bottles of Examples 1-8 are suitable for spraying fragrant EA liquids that emit pleasant fragrant odors for extended periods of time, effectively for the usable life of the spray bottle. Furthermore, as discussed above, the fragrant compounds are capable of being diffused into the water in a controlled manner, and the diffusion process may occur simultaneously with the electrochemical activation of the liquid.

While the present disclosure has been described with reference to preferred embodiments, workers skilled in the art will recognize that changes may be made in form and detail without departing from the spirit and scope of the disclosure.

1. A device for dispensing a fragrant, electrochemically-activated liquid, the device comprising:
an electrolysis cell configured to electrochemically activate the liquid and to diffuse one or more fragrant compounds into the liquid to provide the fragrant, electrochemically-activated liquid;
a switch configured to be actuated between a first state and a second state, wherein the switch energizes the electrolysis cell in the first state and de-energizes the electrolysis cell in the second state; and
a dispenser located downstream from the electrolysis cell and configured to dispense the fragrant, electrochemically-activated liquid.

2. The device of claim 1, wherein the electrolysis cell comprises:
a cell housing;
an anode electrode disposed within the cell housing; and
a cathode electrode disposed within the cell housing;
wherein at least one of the housing component, the anode electrode, and the cathode electrode compositionally comprising a polymeric material and a supply of the one or more fragrant compounds.

3. The device of claim 2, wherein the electrolysis cell further comprises an ion exchange membrane disposed within the cell housing between the anode electrode and the cathode electrode.

4. The device of claim 2, wherein the polymeric material is selected from the group consisting of polyethylenes, polypropylenes, ethylene propylene rubbers, ethylene vinyl acetates, styrene-block copolymers, poly vinyl chlorides, and combinations thereof.

5. The device of claim 2, wherein a concentration of the one or more fragrant compounds in the composition of the cell housing ranges from about 1% by weight to about 40% by weight.

6. The device of claim 5, wherein the concentration of the one or more fragrant compounds in the composition of the cell housing ranges from about 3% by weight to about 30% by weight.

7. The device of claim 1, wherein a concentration of the one or more fragrant compounds in the fragrant, electrochemically-activated liquid dispensed from the dispenser ranges from about 1 part-per-million by volume to about 1% by volume.

8. The device of claim 1, wherein the concentration of the one or more fragrant compounds in the fragrant, electrochemically-activated liquid dispensed from the dispenser ranges from about 10 parts-per-million by volume to about 1,000 parts-per-million by volume.

9. An electrolysis cell comprising:
a component at least partially defining a reaction chamber of the electrolysis cell, the component comprising a polymeric material and one or more fragrant compounds;
an ion exchange membrane;
a first electrode disposed adjacent to a first side of the ion exchange membrane; and
a second electrode disposed adjacent to a second side of the ion exchange membrane, the second side being an opposing side from the first side.

10. The electrolysis cell of claim 9, wherein the polymeric material is selected from the group consisting of polyethylenes, polypropylenes, ethylene propylene rubbers, ethylene vinyl acetates, styrene-block copolymers, poly vinyl chlorides, and combinations thereof.

11. The electrolysis cell of claim 9, wherein the polymeric material comprises an acrylonitrile-butadiene-styrene copolymer.

12. The electrolysis cell of claim 9, wherein a concentration of the one or more fragrant compounds in the composition of the cell housing ranges from about 1% by weight to about 40% by weight.

13. The electrolysis cell of claim 9, wherein the concentration of the one or more fragrant compounds in the composition of the cell housing ranges from about 3% by weight to about 30% by weight.

14. The electrolysis cell of claim 9, wherein the component comprises a cell housing of the electrolysis cell.

15. A method for dispensing a fragrant, electrochemically-activated liquid, the method comprising:
providing a liquid to an electrolysis cell;
electrochemically activating a liquid in the electrolysis cell; and
diffusing one or more fragrant compounds from the electrolysis cell to the liquid.

16. The method of claim 15, wherein diffusing the one or more fragrant compounds from the electrolysis cell to the liquid is performed in a substantially simultaneous manner with electrochemically activating the liquid in the electrolysis cell.

17. The method of claim 15, wherein electrochemically activating the liquid in the electrolysis cell comprises:
introducing the liquid into the electrolysis cell, the electrolysis cell having at least one cathode electrode and at least one anode electrode; and
applying a voltage potential across the at least one cathode electrode and the at least one anode electrode.

18. The method of claim 17, and further comprising maintaining separation of at least two portions of the liquid with at least one ion exchange membrane disposed between the at least one cathode electrode and the at least one anode electrode.

19. The method of claim 15, wherein diffusing the one or more fragrant compounds from the electrolysis cell to the liquid comprises diffusing the one or more fragrant compounds from a housing component of the electrolysis cell.

20. The method of claim 15, wherein a concentration of the one or more fragrant compounds in the fragrant, electrochemically-activated liquid ranges from about 1 part-per-million by volume to about 1% by volume.
